(19) United States
(12) Patent Application Publication
(10) Pub. No.: US 2003/0144403 A1
(43) Pub. Date: Jul. 31, 2003

(54) Use of a combination of a functionalised organosilane-based compound and a coupling activator as a coupling system in dienic elastomer compositions containing a white filler

(76) Inventors: Pierre Barruel, Tassin La Demi-Lune (FR); Nathalie Guennouni, Irigny (FR); Gerard Mignani, Lyon (FR); Herve Parisot, Caluire (FR); Jean-Claude Tardivat, Clermont-Ferrand (FR)

Correspondence Address: BURNS DOANE SWECKER & MATHIS L L P, POST OFFICE BOX 1404, ALEXANDRIA, VA, 22313-1404, US

(21) Appl. No.: 10/168,825

(22) PCT Filed: Dec. 22, 2000
(86) PCT No.: PCT/FR00/03667

(30) Foreign Application Priority Data
Dec. 30, 1999 (FR) 99/6709
Jun. 16, 2000 (FR) 00/07702

(51) Int. Cl. C08K 3/34; C08K 3/18

(52) U.S. Cl. 524/492; 524/430

(57) ABSTRACT

The invention relates to the use of a combination (i) of a member of a group of coupling agents based on organosilanes of formula (I), each with a double ethylenic bond activated (2i) with a very small quantity of a coupling activator consisting especially of an organic peroxide; as a white filler-elastomer coupling system in dienic rubber compositions (s) containing a white filler, especially a siliceous white filler, as a reinforcing filler. The organosilanes correspond to formula (I) (R¹O)ₙ(R²)₃₋ₐSiZ, wherein R¹ and R² are monovalent hydrocarbonated groups, a is a number chosen from 1, 2 and 3, and Z is a function containing an activated ethylenic double bond, chosen especially from a maleamic acid, acrylamide, acrylic or isomaleimide function.

The field of the present invention is that of the use of a combination (i) of a member of a group of coupling agents which is formed by organosilanes each carrying an ethylenic double bond activated with (2i) a very small amount of a suitable coupling activator, such as a white-filler/elastomer coupling system in diene rubber compositions, comprising a white filler as reinforcing filler. The invention also relates to the diene elastomer compositions obtained by the use of the said combination, and to the diene elastomer articles having a body comprising the aforementioned compositions.

The types of elastomer articles in which the invention is most useful are those subject especially to the following stresses: variations in temperature and/or variations in high-frequency stressing in dynamic mode; and/or a high static stress: and/or extensive flexural fatigue in dynamic mode. Such articles are, for example: conveyor belts, power transmission belts, flexible pipes, expansion joints, seals for domestic electrical appliances, supports acting as vibration dampers for engines, either with metal plates or with a hydraulic fluid inside the elastomer, cables, cable jackets, shoe soles and cable-car wheels.

The field of the invention is that of a high-performance use capable of providing elastomer compositions which have, in particular: for great ease of processing the as-prepared compounds, particularly in extrusion and calendering operations, theological properties marked by the lowest possible viscosity values; in order to achieve excellent productivity of the vulcanization plant, vulcanization times as short as possible; and, in order to withstand the abovementioned operating stresses, excellent reinforcing properties conferred by a filler, in particular optimum values of the tensile elastic modulus, tensile strength and abrasion resistance.

To achieve such an objective, many solutions have been proposed which are essentially concentrated on the use of one or more elastomers, particularly one or more diene elastomers, modified by a white filler, especially silica, as reinforcing filler. It is known, in general, that in order to obtain the optimum reinforcing properties imparted by a filler, it is necessary for the latter to be present in the diene elastomer matrix in a final form which is both as finely divided as possible and distributed as homogeneously as possible. Now, such conditions can be achieved only when the filler can very easily, on the one hand, be incorporated into the matrix during the mixing with the diene elastomer(s) and be deagglomerated and, on the other hand, be homogeneously dispersed in the elastomer matrix. The use of a single reinforcing white filler, especially a single reinforcing silica, has proved to be unsuitable because of the low level of certain properties of such compositions, and consequently of certain properties of the articles using these compositions.

For reciprocal affinity reasons, the white filler particles, especially silica particles, have an annoying tendency, in the elastomer matrix, to agglomerate together. These filler/filler interactions have the undesirable consequence of limiting the reinforcing properties to a level substantially below that which it would be theoretically possible to achieve if all the white-filler/elastomer bonds capable of being created during the mixing operation were actually obtained.

In addition, the use of the white filler raises processing difficulties due to the filler/filler interactions which, in the uncured state, tend to increase the viscosity of the elastomer compositions, at the very least so as to make them more difficult to process.

A man skilled in the art knows that it is necessary to use a coupling agent, sometimes called a bonding agent, whose function is to ensure coupling between the surface of the white-filler particles and the elastomer, while at the same time facilitating the dispersion of this white filler within the elastomeric matrix.

The term “coupling” agent (for white-filler/elastomer coupling) is understood to mean, in a known manner, an agent capable of creating sufficient coupling, of a chemical and/or physical nature, between the white filler and the diene elastomer; the simplified general formula of such an at least difunctional coupling agent is, for example, “Y-B-X”, in which:

Y represents a functional group (functional group “Y”) capable of physically and/or chemically bonding to the white filler, such a bond possibly being created, for example, between a silicon atom of the coupling agent and the hydroxyl groups (OH) on the surface of the white filler (for example, the surface silanols when toe filler is silica);

X represents a functional group (functional group “X”) capable of physically and/or chemically bonding to the diene elastomer, for example via a sulphur atom;

B represents a hydrocarbon group allowing Y to be linked to X.

Coupling agents must in particular not be confused with simple white-filler coating agents which, in a known manner, may include the functional group Y, which is active with respect to the white filler, but which do not contain the functional group X, which is active with respect to the diene elastomer.

Coupling agents, especially silica/elastomer coupling agents, have been described in a large number of documents, the most widely known being difunctional alkoxysilanes.

Thus, Patent Application FR-A-2 094 859 has proposed the use of a mercaptosilane to increase the affinity of silica with the elastomer matrix. It has been demonstrated and is nowadays well-known that mercaptosilanes, and in particular γ-mercaptopropyl-trimethoxysilane or γ-mercaptopropyltriethoxysilane, are capable of providing excellent silica/elastomer coupling properties, but that the industrial use of these coupling agents is not possible because of the high reactivity of the —SH functional groups which very rapidly lead, during the preparation of the rubber-type elastomer composition in an internal mixer, to premature vulcanization, also called “scorching”, to high viscosities and, eventually, to compositions which are virtually impossible to work and to process on an industrial scale. To illustrate this impossibility of using such coupling agents and rubber compositions containing them on an industrial scale, mention may be made of documents FR-A-2 206 330 and U.S. Pat. No. 4,002,594.

To remedy this drawback, it has been proposed to replace these mercaptosilanes with polysulphide-type alkoxysilanes, especially bis[tri(C₁-C₄)alkoxylsilyl-propyl] polysulphides as described in many patents or patent applications (see, for example, FR-A-2 206 330, U.S. Pat. No. 3,842,111, U.S. Pat. No. 3,873,489, U.S. Pat. No. 3,978,103 and U.S. Pat. No. 3,997,581). Among these polysulphides, mention may especially be made of bis(3-triethoxysilylpropyl) tetrasulphide (abbreviated to TESPT) which is generally considered today as the product providing, for silica-filled vulcanized compositions, the best compromise in terms of scorch resistance, processability and reinforcing power, but the known drawback of which is that it is very expensive (see, for example, U.S. Pat. No. 5,652,310, U.S. Pat. No. 5,684,171 and U.S. Pat. No. 5,684,172).

In the light of the prior art, it is therefore apparent that there is an unsatisfied need in high-performance uses or coupling agents based on functionalized silanes in diene elastomer compositions comprising a Siliceous material as reinforcing filler, or more generally comprising a reinforcing white filler.

The Applicant has discovered during its research that, unexpectedly, a combination (i) of a member of a group of coupling agents which is formed by organoxysilanes each carrying an activated double bond with (2i) a very small amount of a suitable coupling activator provides a coupling performance superior to that associated with the use of polysulphide-type alkoxysilanes, especially TESPT, and also avoids the premature scorch problems and processing problems associated with an excessively high viscosity of the diene elastomer compositions in the uncured state, especially specific to mercaptosilanes.

The coupling agent of interest in the present invention has the essential characteristic of carrying an activated ethylenic double bond (functional group “X”) allowing it to be grafted onto the diene elastomer. The term “activated” bond is understood to mean, in a known manner, a bond rendered more able to react (in the present case, with the diene elastomer). Of course, to fulfil its role of coupling agent (for white-filler/diene-elastomer coupling), it also carries an organoxysilyl functional group (functional group “Y”) allowing it to be grafted onto the reinforcing white filler.

Organoxysilanes, such as alkoxysilanes for example, carrying an activated ethylenic double bond are known to those skilled in the art, especially as coupling agents (for white-filler/diene-elastomer coupling) in rubber compositions; cf. documents U.S. Pat. No. 4,370,448, U.S. Pat. No. 4,603,158, DE-A-4 319 142 and the patent application published under No. JP64-29385, which describe in detail such known compounds and/or the processes for obtaining them.

The ethylenic double bond is usually activated by the presence of an adjacent electron-attracting group, that is to say one fixed on one of the two carbon atoms of the ethylenic double bond. It will be recalled that, by definition, an “electron-attracting” group is a radical or functional group capable of attracting electrons to itself more than does a hydrogen atom occupying the same place in the molecule in question. This electron-attracting or “activating” group is preferably chosen from radicals carrying at least one of the bonds C═O, C═C, C≡C, OH, OR (R being an alkyl) or OAr (Ar being an aryl) or at least one sulphur and/or nitrogen atom or at least one halogen.

The Applicant has therefore discovered a combination (i) of a member of a group of coupling agents which is formed by organoxysilanes each carrying an activated double bond, chosen from agents of this type which are known in the prior art, with (2i) a very small amount of a suitable coupling activator, which makes it possible to satisfy the need of being able to have the desired optimized coupling performance.

More specifically, the present invention, according to its first subject, relates to the use:

→of a combination based on:

(i) at least one coupling agent chosen from the group of coupling agents each member of which is a compound essentially consisting of a functionalized organosilane of formula:

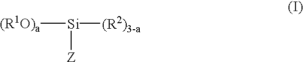

in which:

the symbols R¹, which are identical or different, each represent a monovalent hydrocarbon group chosen from: a linear or branched alkyl radical having from 1 to 4 carbon atoms; a linear or branched alkoxyalkyl radical having from 2 to 6 carbon atoms; a cycloalkyl radical having from 5 to 8 carbon atoms; and a phenyl radical;

the symbols R², which are identical or different, each represent a monovalent hydrocarbon group chosen from: a linear or branched alkyl radical having from 1 to 6 carbon atoms; a cycloalkyl radical having from 5 to 8 carbon atoms; and a phenyl radical;

Z is a functional group, comprising an activated ethylenic double bond (functional group X) intended to be grafted onto the diene elastomer(s) during the vulcanization step by forming a covalent bond with this (these) elastomer(s), especially a functional group chosen from:

a maleamic and/or fumaramic acid functional group Z² of formula:

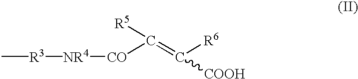

an acrylamide functional group Z³ of formula:

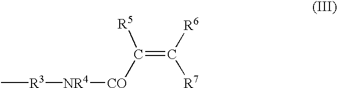

an acrylic functional group Z⁴ of formula:

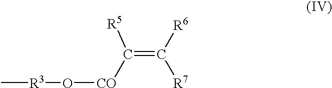

an isomaleimide functional group Z⁵ of formula:

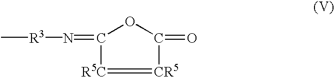

in which formulae:

R³ is a divalent, linear or branched, alkylene hydrocarbon radical having from 1 to 10 carbon atoms, possibly interrupted by at least one oxygen-substituted heteroatom whose free valency carried by a carbon atom is linked to tie Si atom;

the symbols R⁴, R⁵, R⁶ and R⁷, which are identical to or different from one another, each represent a hydrogen atom or a monovalent hydrocarbon group chosen from: a linear or branched alkyl radical having from 1 to 6 carbon atoms; and a phenyl radical;

a is a number chosen between 1, 2 and 3;

and (2i) from 0.05 to a value less than 1 part by weight, per 100 parts by weight of diene elastomer(s), of at least one coupling activator consisting of a radical initiator of the type of those with thermal initiation;

→as a white-filler/elastomer coupling system in the compositions comprising:

(3i) at least one diene elastomer chosen from: homopolymers obtained by the polymerization of a diene monomer carrying two conjugated or unconjugated ethylenic double bonds; copolymers obtained by the copolymerization of at least two conjugated or unconjugated dienes or by the copolymerization of one or more conjugated or unconjugated dienes with one or more ethylenically unsaturated monomers; natural rubber; copolymers obtained by the copolymerization of isobutene and isoprene, and the halogenated versions of these copolymers; and a mixture of the aforementioned elastomers together;

and (4i) a white filler as reinforcing filler.

As indicated above, the coupling agents or constituents (i) are compounds essentially consisting of a functionalized organosilane of formula (i). The expression “essentially” should be interpreted as meaning that the functionalized organosilane used within the context of the present invention may be in the form of a functionalized organosilane of formula (I) in the pure state or in the form of a mixture of light organosilanes with a variable molar amount, generally less than or equal to 35 mol % in the mixture, of other organosiliceous compound(s) comprising at least one linear, cyclic and/or networked siloxane oligomer formed from units satisfying the following formulae: (R³)₂ZSiO_{1/2} (VI-1), R⁸ZSiO_{2/2} (VI-2) and/or ZSiO_{3/2} (VI-3) in which: the symbols R⁸, which are identical or different, each represent a monovalent radical chosen from the hydroxyl radical and/or the radicals satisfying the definitions of OR¹ and R²; the symbols R¹, R² and Z are as defined above; and the total number of units of formulae (VI-1) to (VI-3), per oligomer molecule, is an integer or fractional number greater than 1, preferably ranging from 2 to a value of less than 3. The abovementioned molar quantity is expressed as a number of Si atoms (or of organosiliceous units) belonging to the other organosiliceous compound(s) per 100 Si atoms present in the total mixture. To the knowledge of the Applicant, such siloxane oligomers are novel products which form another aspect of the present invention according to its first subject.

The amount of organosiliceous compound(s) will essentially vary according to the operating conditions for carrying out the processes that can be used for preparing the functionalized organosilane of formula (I). When the aim is a mixture of products, if it is desired to be able to have a purified functionalized organosilane of formula (I) or one in the pure state, a purification step is carried out, for example by distillation under reduced pressure or by liquid chromatography.

In the above formulae, the preferred radicals R¹ are chosen from the following radicals: methyl, ethyl, n-propyl, isopropyl, n-butyl, CH₃OCH₂—, CH₃OCH₂CH₂—, CH₃OCH(CH3)CH₂—; more preferably, the radicals R¹ are chosen from the radicals: methyl, ethyl, n-propyl and isopropyl. The preferred radicals R² are chosen from the following radicals: methyl, ethyl, n-propyl, isopropyl, n-butyl, n-pentyl, cyclohexyl and phenyl; more preferably, the radicals R² are methyls.

The functional groups represented by the symbol Z are preferably chosen from the functional groups of formulae (II) to (V) in which:

the symbol R³ represents an alkylene residue which satisfies the following formulae:

—(CH₂)₂—, —(CH₂)₃—, —(CH₂)₄—, —CH₂—CH(CH₃)—, —(CH₂—)₂—CH(CH₃)—(CH₂)—, —(CH₂)₃—O—(CH₂)₃—, —(CH₂)₃—O—CH₂—CH(CH₃)—(CH₂)—, —(CH₂)₃—O—CH₂CH(OH)CH₂—; more preferably, R³ is a —(CH₂)₂— or —(CH₂)₃— residue;

the symbols R⁴, R⁵, R⁶ and R⁷ are chosen from: a hydrogen atom, and methyl, ethyl, n-propyl and n-butyl radicals; more preferably, these symbols are chosen from a hydrogen atom and a methyl radical.

Typical functionalized organosilanes satisfying formula (I) are those of formula:

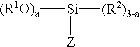

where:

the symbols R¹ are chosen from methyl and ethyl radicals, the symbol R² is a methyl radical,

a is a number equal to 2 or 3,

the symbol Z is chosen from the functional groups of the following formulae:

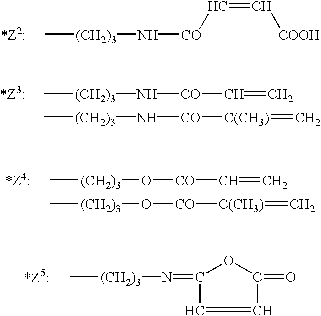

Some of these functionalized organosilanes are known as white-filler/diene-elastomer coupling agent and have been described, for example, in JP-A-64/29385, U.S. Pat. No. 4,603,158, U.S. Pat. No. 4,370,448, U.S. Pat. No. 5,484,848 and EP-A-0 278 157.

As coupling activators or constituents (2i), the use of which is essential for white-filler/diene-elastomer coupling, one or more compounds capable of activating, that is to say increasing, the coupling function of the coupling agent described above are suitable; such a coupling agent, used in very small amounts, is a radical initiator of the type of those which are thermally initiated.

In a known manner, a radical initiator is an organic compound capable, after being activated by supplying energy, of generating free radicals in situ within its surrounding medium. The radical initiator used in the invention is an initiator of the thermally initiated type, that is to say one in which the supply of energy, in order to create the free radicals, must be in a thermal form. It is thought that the generation of these free radicals promotes, during the manufacture (thermomechanical mixing) of the rubber compositions, better interaction between the coupling agent and the diene elastomer.

It is preferred to choose a radical initiator whose decomposition temperature is less than 180° C., more preferably less than 160° C., such temperature ranges making it possible to derive full benefit from the activation effect of the coupling, during the manufacture of the rubber compositions.

The coupling activator is preferably chosen from the group consisting of peroxides, hydroperoxides, azido compounds, bis(azo) compounds, peracids, peresters or a mixture of two or of more than two of these compounds.

More preferably, the coupling activator is chosen from the group consisting of peroxides, bis(azo) compounds, peresters or a mixture of two or of more than two of these compounds. As examples, mention may especially be made of benzoyl peroxide, acetyl peroxide, lauryl peroxide, cumyl peroxide, tert-butyl peroxide, tert-butyl peracetate, tert-butyl hydroperoxide, cumene hydroperoxide, tert-butyl cumyl peroxide, 2,5-dimethyl-2,5-bis(tert-butyl)hex-3-yne peroxide, 1,3-bis(tert-butylisopropyl)benzene peroxide, 2,4-dichlorobenzoyl peroxide, tert-butyl perbenzoate, 1,1-bis(tert-butyl)-3,3,5-trimethylcyclohexane peroxide, 1,1′-azobis(isobutyronitrile) (abbreviated to “AIBN”), 1,1′-azobis(secpentylnitrile) and 1,1′-azobis(cyclohexanecarbonitrile).

According to one particularly preferred embodiment, the radical initiator used is 1,1-bis(tert-butyl)-3,3,5-trimethylcyclohexane peroxide. Such a compound is sold, for example, by Flexsys under the name TRIGONOX 29-40 (40% by weight of peroxide on a solid calcium carbonate support).

According to another advantageous embodiment of the invention, the radical initiator used is 1,1′-azobis(isobutyronitrile). Such a compound is sold, for example, by DuPont de Nemours under the name VAZO 64.

As indicated above, the radical initiator is used in a very small amount, namely an amount ranging from 0.05 to a value of less than 1 part by weight per 100 parts by weight of diene elastomer(s).

Below the aforesaid minimum the effect is insufficient, whereas above the maximum indicated there is no longer an improvement in the coupling and there is a risk of scorching (premature crosslinking), especially if the radical initiator used is liable to act as a vulcanization agent at higher contents (especially in the case of peroxides).

In the majority of cases, it has been found that a particularly low content, preferably ranging from 0.05 to 0.5 part per 100 parts of elastomer(s), was already sufficient to effectively activate the coupling function of constituent (i); particularly advantageously, a content of radical initiator ranging from 0.1 to 0.3 part per 100 parts of elastomer(s) will be chosen. At such low contents as those recommended here, it is obvious to a person skilled in the art that thermally initiated radical initiators, whatever they are, are not capable of crosslinking the compositions (which would then result in a significant increase in stiffness) even if these initiators possess, as the case may be, at much higher contents, the ability to crosslink diene elastomers.

Of course, the optimum content of coupling agent or constituent (2i) will be adjusted, within the ranges indicated above, depending on the particular conditions of carrying out the invention, namely on the diene elastomer type or constituent (3i), on the nature of the reinforcing white filler or constituent (4i) and on the nature and the amount of the coupling agent(s) or constituent (i) used. Preferably, the amount of coupling activator represents between 1% and 10%, more preferably between 2% and 6%, by weight with respect to the amount of the coupling agent(s).

A second subject of the present invention consists of diene elastomer compositions comprising a reinforcing white filler, these being obtained by the use of the combination (i) of at least one coupling agent chosen from the group of coupling agents each member of which is a compound essentially consisting of a functionalized organosilane of formula (I), referred to above, with (2i) the very small amount of coupling activator(s), also referred to above.

More specifically, these compositions comprise (the parts are given by weight):

per 100 parts of elastomer(s) or constituent (3i),

10 to 150 parts, preferably 20 to 100 and even more preferably 30 to 80 parts, of reinforcing white filler or constituent (4i),

0.5 to 20 parts, preferably 1 to 15 parts and even more preferably 3 to 12 parts, of coupling agent(s) or constituent (i), per 100 parts of reinforcing white filler,

and 0.05 to a value of less than 1 part, preferably 0.05 to 0.5 part and even more preferably 0.1 to 0.3 part, of coupling activator(s) or constituent (2i) per 100 parts of diene elastomer(s).

In the present specification, the expression “reinforcing white filler” is understood to mean a white filler capable of reinforcing by itself, without means other than a coupling agent, a natural or synthetic rubber-type elastomer composition.

It does not matter in which physical state the reinforcing white filler is in, that is to say the said filler may be in the form of powder, microbeads, granules or balls.

Preferably, the reinforcing white filler or constitutent (4i) consists of silica, alumina or a mixture of these two species.

More preferable, the reinforcing white filler consists of silica, by itself or as a mixture with alumina.

By way of silica capable of being used in the invention, all precipitated or pyrogenic silicas known to those skilled in the art having a BET specific surface area≦than to 450 m²/g are suitable. Precipitated silicas, which may be conventional or highly dispersible, are preferred.

The expression “highly dispersible silica” is understood to mean any silica which is able to deagglomerate and to be very finely dispersed in a polymeric matrix as can be observed on thin cross sections in an electron or optical microscope. As non-limiting examples of highly dispersible silicas, mention may be made of those having a CTAB specific surface area of less than or equal to 450 m²/g and particularly those described in U.S. Pat. No. 5,403,570 and Patent Applications WO-A-95/09127 and WO-A-95/09128, the content of which is incorporated here. Treated precipitated silicas such as, for example, the silicas “doped” with aluminium described in Patent Application EP-A-0 735 088, the content of which is also incorporated here, are also suitable.

More preferably, very suitable are precipitated silicas having:

a CTAB specific surface area ranging from 100 to 240 m²/g, preferably from 100 to 180 m²/g,

a BET specific surface area ranging from 100 to 250 m²/g, preferably from 100 to 190 m²/g,

a DOP oil absorption of less than 300 ml/100 g, preferably ranging from 200 to 295 ml/100 g,

a BET specific surface area/CTAB specific surface area ratio ranging from 1.0 to 1.6.

Of course, the term “silica” is also understood to mean cuts of various silicas. The CTAB specific surface area is determined according to the NFT 45007 (November 1987) method. The BET specific surface area is determined according to the Brunauer, Emmet and Teller method described in “The Journal of the American Chemical Society, Vol. 80, page 309 (1938)” corresponding to the NFT 45007 (November 1987) standard. The DOP oil absorption is determined using dioctyl phthalate according to the NFT 30-022 (March 1953) standard.

As reinforcing alumina, it is advantageous to use a highly dispersible alumina having:

a BET specific surface area ranging from 30 to 400 m²/g, preferably from 80 to 250 m²/g,

a mean particle size of at most equal to 500 nm, preferably at most equal to 200 nm, and

a high content of Al—OH reactive functional groups on the surface,

as described in document EP-A-0 810 258.

As non-limiting examples of such reinforcing aluminas, mention may especially be made of the aluminas A125, CR125, D65CR from Baikowski.

The coupling agent described above could be pregrafted (via the “Y” functional group) onto the reinforcing white filler, the filler thus “precoupled” possibly being subsequently bonded to the elastomer by means of the “X” free functional group.

Elastomers or constituents (3i) that can be used for the compositions according to the second subject of the invention are understood more specifically to be:

(1) homopolymers obtained by the polymerization of a conjugated diene monomer having from 4 to 22 carbon atoms, such as, for example: 1,3-butadiene, 2-methyl-1,3-butadiene, 2,3-dimethyl-1,3-butadiene, 2,3-diethyl-1,3-butadiene, 2-methyl-3-ethyl-1,3-butadiene, 2-chloro-1,3-butadiene, 2-methyl-3-isopropyl-1,3-butadiene, 1-phenyl-1,3-butadiene, 1,3-pentadiene and 2,4-hexadiene;

(2) copolymers obtained by the mutual copolymerization of at least two of the aforementioned conjugated dienes or by the copolymerization of one or more of the aforementioned conjugated dienes with one or more ethylenically unsaturated monomers chosen from:

aromatic vinyl monomers having from 8 to 20 carbon atoms, such as, for example: styrene, ortho-, meta- or paramethylstyrene, the commercial mixture “vinyl toluene”, para-tert-butylstyrene, methoxystyrenes, chlorostyrenes, vinylmycetylene, divinylbenzene and vinylnaphthalene;

vinyl nitrile monomers having from 3 to 12 carbon atoms, such as, for example, acrylonitrile and methacrylonitrile;

acrylic ester monomers derived from acrylic acid or methacrylic acid with alkanols having from 1 to 12 carbon atoms, such as, for example, methyl acrylate, ethyl acrylate, propyl acrylate, n-butyl acrylate, isobutyl acrylate, 2-ethylhexyl acrylate, methyl methacrylate, ethyl methacrylate, n-butyl methacrylate and isobutyl methacrylate;

the copolymers may contain between 99% and 20% by weight of diene units and between 1% and 80% by weight of aromatic vinyl, vinyl nitrile and/or acrylic ester units;

(3) natural rubber;

(4) copolymers obtained by the copolymerization of isobutene and isoprene (butyl rubber), and the halogenated, particularly chlorinated or brominated, versions of these copolymers;

(5) a blend of several of the aforementioned elastomers (1) to (4) together.

Preferably, use is made of one or more elastomers chosen from (1) polyisoprene [or poly(2-methyl-1,3-butadiene)]; (2) poly(isoprene-butadiene), poly(isoprene-styrene), poly(isoprene-butadiene-styrene); (3) natural rubber; (4) butyl rubber; (5) a blend of the abovenamed elastomers (1), (2), (3), (4) together; (5′) a blend containing a majority amount (ranging from 51% to 99.5% and, preferably, from 70% to 99% by weight) of polyisoprene (1) and/or of natural rubber (3) and a minority amount (ranging from 49% to 0.5% and, preferably, from 30% to 1% by weight) of polybutadiene, polychloroprene, poly(butadiene-styrene) and/or poly(butadiene-acrylonitrile).

The compositions according to the invention furthermore contain all or some of the other constituents and auxiliary additives normally used in the field of elastomer and rubber compositions.

Thus, all or some of the following other constituents and additives may be used:

with regard to the vulcanization system, mention may be made of, for example:

vulcanization agents chosen from sulphur or sulphur-donating compounds such as, for example, thiuram derivatives;

vulcanization accelerators such as, for example, guanidine derivatives, thiazol derivatives or sulphenamide derivatives;

vulcanization activators such as, for example, zinc oxide, stearic acid and zinc stearate;

with regard to other additive(s), mention may be made of, for example:

a conventional reinforcing filler such as carbon black (in this case, the reinforcing white filler used constitutes more than 50% of the weight of the reinforcing white filler +carbon black combination);

a barely reinforcing or non-reinforcing conventional white filler such as, for example, clays, bentonite, talc, chalk, kaolin, titanium dioxide or a mixture of these species;

antioxidants;

antiozonants such as, for example, N-phenyl-N′-(1,3-dimethylbutyl)-p-phenylenediamine;

plasticizers and processing aids.

With regard to processing aids, the compositions according to the invention may contain agents for coating the reinforcing filler, comprising, for example, only the Y functional group, which are capable in a known manner, by an improvement in the dispersion of the filler in the rubber matrix and by a lowering of the viscosity of the compositions, to improve the processability of the compositions in the green or uncured state. Such processing aids consist, for example, in polyols, polyethers (for example, polyethylene glycols), primary, secondary or tertiary amines (for example, trialkanolamines) and α,ω-dihydroxylated polydimethylsiloxanes. Such a processing aid, when one is used, is employed in an amount of 1 to 10 parts by weight, and preferably 2 to 8 parts, per 100 parts of reinforcing white filler.

The process for preparing diene elastomer compositions comprising a reinforcing white filler or constituent (4i), at least one coupling agent or constituent (i) and at least one coupling activator or constituent (2i) may be carried out in a conventional operating mode in one or too steps.

According to the one-step process, all the necessary constituents, with the exception of the vulcanization agent(s) and, possibly, the vulcanization accelerator(s) and/or the vulcanization activator(s), are introduced into and mixed in a standard internal mixer, for example of the BANBURY type or of the BRABENDER type. The result of this first mixing step is mixed further on an external mixer, generally a roll mill, and then the vulcanization agent(s) and, possibly, the vulcanization accelerator(s) and/or the vulcanization activator(s) are added to it.

It may be advantageous for the preparation of certain articles to employ a two-step process, both steps being carried out in an internal mixer. In the first step, all the necessary constituents, with the exception of the vulcanization agent(s) and, possibly, the vulcanization accelerator(s) and/or the vulcanization activator(s), are introduced and mixed. The object of the second step which follows is essentially to make the mixture undergo a complementary heat treatment. The result of this second step is then also further mixed on an external mixer in order to add thereto the vulcanization agent(s) and, possibly, the vulcanization accelerator(s) and/or the vulcanization activator(s).

The work phase in the internal mixer is generally carried Out at a temperature ranging from 80° C. to 200° C., preferably from 80° C. to 180° C. This first work phase is followed by the second work phase in the external mixer, operating at a lower temperature, generally of less than 120° C. and preferably ranging from 25° C. to 70° C.

The final composition obtained is then calendered, for example, in the form of a sheet, or of a profile that can be used for the manufacture of elastomer articles.

The vulcanization (or curing) is carried out in a known manner at a temperature generally ranging from 130° C. to 200° C. for a sufficient time which may vary, for example between 5 and 90 minutes, depending especially on the curing temperature, on the vulcanization system adopted and on the vulcanization kinetics of the composition in question.

It goes without saying that the present invention, according to its second subject, relates to the elastomer compositions described above both in the green state (i.e. before curing) and in the cured state (i.e. after crosslinking or vulcanization).

The elastomer compositions serve for producing elastomer articles having a body comprising the said compositions. These compositions are particularly useful for producing articles consisting of engine mounts, shoe soles, cable-car wheels, seals for domestic electrical appliances, and cable jackets.

The following examples illustrate the present invention.

### EXAMPLE

The purpose of this example is to demonstrate the improved coupling performance of a compound essentially consisting of an alkoxysilane with an activated double bond of formula (I) when it is combined with a peroxide as a thermally initiated radical initiator. This performance is compared, on the one hand, with that of a conventional TESPT coupling agent and, on the other hand, with that of a compound essentially consisting of an alkoxysilane with an activated double bond of formula (I) itself, when the latter is used alone, i.e. when it is not combined with a radical initiator.

4 diene elastomer compositions representative of formulations for shoe soles are compared. These 4 compositions are identical, apart from the following differences:

composition No. 1 (control 1): TESPT coupling agent (4 percent or parts by weight per one hundred parts of elastomers) used alone;

composition No. 2 (control 2): TESPT (4 percent) combined with 0.12 percent of peroxide;

composition No. 3 (control 3): compounds which essentially consist of an alkoxysilane having an activated double bond of formula (I) consisting of N-[γ-propyl (methyldiethoxy) silane] maleamic acid (4.3 percent), used alone;

composition No. 4 (example according to the invention): a compound essentially consisting of N-[γ-propyl (methyldiethoxy) silane] maleamic acid (4.3 percent), combined with 0.12 percent of peroxide.

1. Preparation of the Compound Essentially Consisting of N-[γ-propyl(methyldiethoxy)silane]maleamic Acid:

The preparation was carried out in a 2-litre glass reactor fitted with a stirring system and with a dropping funnel. γ-Aminopropylsilane (404.41 g, i.e. 2.113 mol) of formula (C₂H₅O)₂CH₂Si (CH₂)₃NH₂ was gradually added dropwise at a temperature of 10° C. (the reaction temperature) onto a solution of maleic anhydride (215.6 g, i.e. 2.20 mol) in dichloromethane CH₂Cl₂ (773.7 g) as solvent over a period of 1 hour 25 minutes. The reaction mixture was then left for 72 hours at 17° C. After this time, the solvent was removed by evaporation and white crystals based on the desired compound were thus recovered.

The crystals obtained were subjected to proton NMR analysis and silicon (²⁹Si)NMR analysis. The results of these analyses show that the compound obtained contained (the molar percentages indicated below express the number of organosiliceous units per 100 silicon atoms present in the compound obtained):

96 mol % of coded unit D(OC₂H₅)₂ of formula CH₃Z²Si (OC₂H₅)₂ belonging to the maleamic acid silane (present in an amount of 96.6% by weight) of formula:

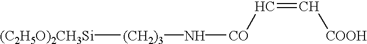

4 mol % of coded units D(OC₂H₅) of formula CH₃Z² (OC₂H₅)SiO_{1/2} belonging to the disiloxane (present in an amount of 3.4% by weight) of formula:

where

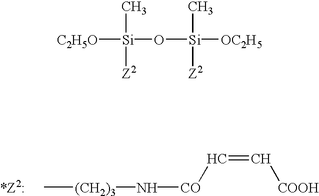

2. Formulation of the Diene Elastomer Compositions:

The following compositions, the formulation of which, expressed in parts by weight, is indicated in Table I given below, were prepared in an internal mixer of the BRABENDER type:

TABLE I

| | Control | Control | Control | |
|---|---|---|---|---|
| Composition | 1 | 2 | 3 | Example |
| NR rubber (1) | 85 | 85 | 85 | 85 |
| BR 1220 rubber (2) | 15 | 15 | 15 | 15 |
| Silica (3) | 50 | 50 | 50 | 50 |
| Zinc oxide (4) | 5 | 5 | 5 | 5 |
| Stearic acid (5) | 2 | 2 | 2 | 2 |
| TESPT silane (6) | 4 | 4 | — | — |
| Maleamic acid silane | — | — | 4.3 | 4.3 |
| compound (7) | | | | |
| TBBS (8) | 2 | 2 | 2 | 2 |
| DPG (9) | 1.4 | 1.4 | 1.4 | 1.4 |
| Sulphur (10) | 1.7 | 1.7 | 1.7 | 1.7 |
| Pure peroxide (11) | — | 0.12 | — | 0.12 |

(1) Natural rubber, of Malaysian origin, sold by Safic-Alcan under the reference SMR 5L;
(2) Polybutadiene rubber having a high content of cis-1,4 addition products, sold by SMPC;
(3) Zeosil 1165 MP silica, sold by Rhodia-Silices;
(4) and (5) Vulcanization activators;
(6) bis(3-Triethoxysilylpropyl) tetrasulphide, sold by Degussa under the name Si-69;
(7) A compound essentially consisting of an alkoxysilane having an activated double bond of formula (I) consisting of N-[γ-propyl(methyl-diethoxy)silane] maleamiic acid, prepared as indicated above in section 1);
(8) N-tert-2-Butyl-benzothiazyl sulphenamide (vulcanization accelerator);
(9) Diphenyl guanidine (vulcanization accelerator);
(10) Vulcanization agent;
(11) 1,1-bis(tert-Butyl)-3,3,5-trimethylcyclohexane peroxide, sold by Flexsys under the name TRIGONOX 29-40, which contains 40% by weight of pure peroxide deposited on a solid calcium carbonate support; the amount indicated in Table I corresponds to the actual proportion of peroxide taken in the pure state, i.e. without the calcium carbonate support.

3. Preparation of the Compositions:

The various constituents were introduced into an internal mixer of the BRABENDER type in the order, at the times and at the temperatures indicated below:

| Time | Temperature | Constituents |
|---|---|---|
| 0 minute | 90° C. | NR rubber |
| 1 minute | | BR rubber |
| 2 minutes | 105° C. | 2/3 silica + TESPT silane |
| | | or maleamic acid silane + |
| | | peroxide (when it is |
| | | used) compound |
| 4 minutes | 120° C. | 1/3 silica + stearic acid + |
| | | zinc oxide |

The contents of the mixer were drained or dropped after 5 minutes. The temperature reached was in the range from 135 to 140° C.

The mixture obtained was then put onto a roll mill, maintained at 30° C., and the TBBS, DPG and sulphur were introduced. After homogenization, the final mixture was calendered in the form of sheets from 2.5 to 3 mm in thickness.

4. Rheological Properties of the Compositions:

The measurements were made on the compositions in the uncured state. Table II below gives the results relating to the rheology test which was carried out at 160° C. for 30 minutes using a MONSANTO 100 S rheometer.

According to this test, the composition to be tested was placed in the test chamber, regulated to the temperature of 160° C., and the resistive torque, opposed by the composition, was measured for a low-amplitude oscillation of a biconical rotor included within the test chamber, the composition completely filling the chamber in question. From the curve of variation in torque as a function of time, the following are determined: the minimum torque which is representative of the viscosity of the composition at the temperature in question; the maximum torque and the delta-torque which are representative of the degree of crosslinking caused by the action of the vulcanization system; the T-90 time needed to obtain a vulcanization state corresponding to 90% of complete vulcanization (this time is taken as being the vulcanization optimum); and the scorch time TS-2 corresponding to the time needed to have an increase of 2 points above the minimum torque at the temperature in question (160° C.) and which is representative of the time during which it is possible to use the uncured compounds at this temperature without having to initiate the vulcanization.

The results obtained are given in Table II.

TABLE II

| Monsanto Rheology | Control 1 | Control 2 | Control 3 | Example |
|---|---|---|---|---|
| Minimum torque | 12.8 | 12.3 | 11.2 | 11.3 |
| Maximum torque | 105 | 106 | 94 | 95 |
| Delta-torque | 94.2 | 95.7 | 82.8 | 83.7 |
| TS-2 (minutes) | 3.5 | 3 | 3.4 | 3.3 |
| TS-90 (minutes) | 6.8 | 6.6 | 6 | 5.9 |

5) Mechanical Properties of the Vulcanized Compositions:

The measurements were made on the optimally vulcanized compositions (temperature: 160° C.; durations for each composition: T-90 times indicated in Table II).

The properties measured and the results obtained are given in Table III below:

TABLE III

| Mechanical properties | Control 1 | Control 2 | Control 3 | Example |
|---|---|---|---|---|
| 10% modulus (1) | 0.80 | 0.82 | 0.76 | 0.70 |
| 100% modulus (1) | 2.5 | 2.65 | 2.2 | 2.45 |
| 300% modulus (1) | 10.5 | 10.9 | 8.4 | 11.3 |
| 400% modulus (1) | 15.8 | 16.4 | 13.6 | 13.1 |
| Elongation at break (1) | 610 | 540 | 650 | 500 |
| Tensile strength (1) | 27.9 | 25 | 27 | 24 |
| Reinforcement indices: | | | | |
| 300% M/100% M | 4.2 | 4.1 | 3.9 | 4.6 |
| 400% M/100% M | 6.3 | 6.2 | 6.2 | 7.4 |
| Shore A hardness (2) | 71 | 72 | 67 | 64 |
| Abrasion resistance (3) | 121 | 120 | 116 | 110 |

(1) The tensile tests were carried out in accordance with the information in the NF T 46-002 standard on H2-type test pieces. The 10%, 100%, 300% and 400% moduli and the tensile strength are expressed in MPa; the elongation at break is expressed in %.
(2) The measurement was made according to the information in the ASTM D 3240 standard. The value given was measured at 15 seconds.
(3) The measurement was made according to the information in the NF T 46-012 standard using method 2 with a rotating test-piece holder. The measured value is the loss of substance (in mm³) by abrasion; the lower this value, the better the abrasion resistance.

Examination of the various results in Tables II and III leads to the following observations. In terms of the uncured compounds, the viscosities are substantially identical between the compositions with and without peroxide. This demonstrates that the addition of peroxide in the recommended very small amounts and under the operating conditions applied has no crosslinking effect on the diene elastomers during the mixing phase in the internal mixer.

After curing, it may be seen that the addition of peroxide has only a barely pronounced influence on the moduli values with TESPT and above all does not modify the reinforcement indices with this silane (comparison of controls 1 and 2).

In contrast, in the case of the composition according to the invention (control 3 and example comparison), the addition of peroxide very substantially increases the moduli, particularly at high elongations, and above all increases the values of the reinforcement indices, these being indicators, known to those skilled in the art, of a significant improvement in the white-filler/elastomer coupling due to the coupling agent(s)/coupling activator(s) combination according to the invention.

1. Use of a combination based on:
(i) at least one coupling agent chosen from the group of coupling agents each member of which is a compound essentially consisting of a functionalized organosilane of formula: 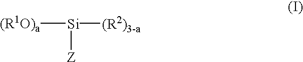
in which:
the symbols R¹, which are identical or different, each represent a monovalent hydrocarbon group chosen from: a linear or branched alkyl radical having from 1 to 4 carbon atoms; a linear or branched alkoxyalkyl radical having from 2 to 6 carbon atoms; a cycloalkyl radical having from 5 to 8 carbon atoms; and a phenyl radical;
the symbols R², which are identical or different, each represent a monovalent hydrocarbon group chosen from: a linear or branched alkyl radical having from 1 to 6 carbon atoms; a cycloalkyl radical having from 5 to 8 carbon atoms; and a phenyl radical;
Z is a functional group, comprising an activated ethylenic double bond (functional group X) intended to be grafted onto the diene elastomer(s) during the vulcanization step by forming a covalent bond with this (these) elastomer(s), especially a functional group chosen from:
a maleamic and/or fumaramic acid functional group Z² of formula: 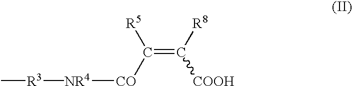
an acrylamde functional group Z³ of formula: 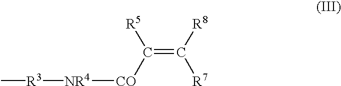
an acrylic functional group Z⁴ of formula: 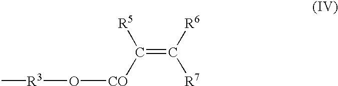
an isomaleimide functional group Z⁵ of formula: 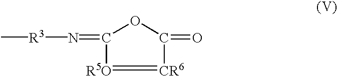
in which formulae:
R³ is a divalent, linear or branched, alkylene hydrocarbon radical having from 1 to 10 carbon atoms, possibly interrupted by at least one oxygen-substituted heteroatom whose free valency carried by a carbon atom is linked to the Si atom;
the symbols R⁴, R⁵, R⁶ and R⁷, which are identical to or different from one another, each represent a hydrogen atom or a monovalent hydrocarbon group chosen from: a linear or branched alkyl radical having from 1 to 6 carbon atoms; and a phenyl radical;
a is a number chosen between 1, 2 and 3;
and (2i) from 0.05 to a value less than 1 part by weight, per 100 parts by weight of diene elastomer(s), of at least one coupling activator consisting of a radical initiator of the type of those with thermal initiation;
→ as a white-filler/elastomer coupling system in the compositions comprising:
(3i) at least one diene elastomer chosen from: homopolymers obtained by the polymerization of a diene monomer carrying two conjugated or unconjugated ethylenic double bonds; copolymers obtained by the copolymerization of at least two conjugated or unconjugated dienes or by the copolymerization of one or more conjugated or unconjugated dienes with one or more ethylenically unsaturated monomers; natural rubber; copolymers obtained by the copolymerization of isobutene and isoprane, and the halogenated versions of these copolymers; and a mixture of the aforementioned elastomers together;
and (4i) a white filler as reinforcing filler.

2. Use according to claims 1, characterized in that, with regard to constituent (i):
the radicals R¹ [lacuna] chosen from the radicals: methyl, ethyl, n-propyl, isopropyl, n-butyl, CH₃OCH₂—, CH₃OCH₂CH₂— and CH₃OCH(CH₃)CH_{2—};
the radicals R² [lacuna] chosen from the radicals: methyl, ethyl, n-propyl, isopropyl, n-butyl, n-pentyl, cyclohexyl and phenyl;
the functional groups represented by the symbol Z are chosen from the functional groups of formulae (II) to (V) in which:
the symbol R³ represents an alkylene residue which satisfies the following formulae: —(CH₂)₂—, —CH₂)₃—, —(CH₂)₄—, —CH₂—CH(CH₃)—, —(CH₂)₂—CH(CH₃)—(CH₂)—, —(CH₂)₃—O—(CH₂)₃—, —(CH₂)₃—O—CH₂—CH(CH₃)—CH₂— and —(CH₂)₃—O—CH₂CH(OH)CH₂—;
the symbols R⁴, R⁵, R⁶ and R⁷ are chosen from: a hydrogen atom and methyl, ethyl, n-propyl and n-butyl radicals.

3. Use according to claim 2, characterized in that the functionalized organosilanes satisfying formula (I) are those of formula: 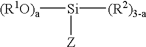
where:
the symbols R¹ are chosen from methyl and ethyl radicals;
the symbol R² is a methyl radical;
a is a number equal to 2 or 3;
the symbol Z is chosen from the functional groups of the following formulae:

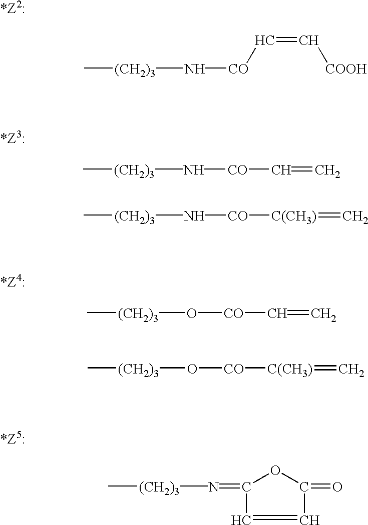

4. Use according to any one of claims 1 to 3, characterized in that the constituent (2i) is chosen from the group consisting of peroxides, hydroperoxides, azido compounds, bis(azo) compounds, peracids, peresters or a mixture of two or of more than two of these compounds.

5. Diene elastomer compositions comprising a reinforcing white filler, these being obtained by the use of the combination (i) of at least one coupling agent chosen from the group of coupling agents each member of which is a compound essentially consisting of a functionalized organosilane of formula (I), defined above in any one of claims 1 to 3, with (2i) the very small amount of at least one coupling activator, which was also defined above in claim 1 or 4.

6. Compositions according to claim 5, characterized in that they comprise (the parts are given by weight):
per 100 parts of elastomer(s) or constituent (3i),
10 to 150 parts of reinforcing white filler or constituent (4i),
0.5 to 20 parts of coupling agent(s) or constituent (i) per 100 parts of reinforcing white filler
and 0.05 to a value of less than 1 part of coupling activator(s) or constituent (2i) per 100 parts of diene elastomer(s).

7. Compositions according to claim 6, characterized in that they comprise:
per 100 parts of elastomer(s) or constituent (3i),
20 to 100 parts of white filler or constituent (4i),
1 to 15 parts of coupling agent(s) or constituent (i) per 100 parts of white filler,
and 0.05 to 0.5 part of coupling activator(s) or constituent (2i) per 100 parts of diene elastomer(s).

8. Compositions according to any one of claims 5 to 7, characterized in that the reinforcing white filler or constituent (4i) consists of silica, alumina or a mixture of these two species.

9. Compositions according to claim 8, characterized in that:
the silica is a conventional or highly dispersible precipitated silica, especially having a BET specific surface area≦than to 450 m²/g;
the alumina is a highly dispersible alumina, especially having a BET specific surface area ranging from 30 to 400 m²/g and a high content of Al—OH reactive functional groups on the surface.

10. Compositions according to any one of claims 5 to 9, characterized in that the diene elastomer(s) or constituent (3i) is (are) chosen from:
(1) homopolymers obtained by the polymerization of a conjugated diene monomer having from 4 to 22 carbon atoms;
(2) copolymers obtained by the mutual copolymerization of at least two of the aforementioned conjugated dienes or by the copolymerization of one or more of the aforementioned conjugated dienes with one or more ethylenically unsaturated monomers chosen from:
aromatic vinyl monomers having from 8 to 20 carbon atoms;
vinyl nitrile monomers having from 3 to 12 carbon atoms;
acrylic ester monomers derived from acrylic acid or methacrylic acid with alkanols having from 1 to 12 carbon atoms;
the copolymers may contain between 99% and 20% by weight of diene units and between 1% and 80% by weight of aromatic vinyl, vinyl nitrile and/or acrylic ester units;
(3) natural rubber;
(4) copolymers obtained by the copolymerization of isobutene and isoprene (butyl rubber), and the halogenated versions of these copolymers;
(5) a blend of several of the aforementioned elastomers (1) to (4) together.

11. Compositions according to claim 10, characterized in that use is made of one or more elastomers chosen from (1) polyisoprene [or poly(2-methyl-1,3-butadiene)]; (2) poly(isoprene-butadiene), poly(isoprene-styrene), poly(isoprene-butadiene-styrene); (3) natural rubber; (4) butyl rubber; (5) a blend of the abovenamed elastomers (1), (2), (3), (4) together; (5′) a blend containing a majority amount (ranging from 51% to 99.5% and, preferably, from 70% to 99% by weight) of polyisoprene (1) and/or of natural rubber (3) and a minority amount (ranging from 49% to 0.5% and, preferably, from 30% to 1% by weight) of polybutadiene, polychloroprene, poly(butadienestyrene) and/or poly(butadiene-acrylonitrile).

12. Compositions according to any one of claims 5 to 11, characterized in that they furthermore contain all or some of the other constituents and auxiliary additives normally used in the field of elastomer and rubber compositions, the said other constituents and additives comprising:
with regard to the vulcanization system:
vulcanization agents;
vulcanization accelerators;
vulcanization activators;
with regard to other additive(s):
a conventional reinforcing filler such as carbon black;
a barely reinforcing or non-reinforcing conventional white filler;
antioxidants;
antiozonants;
plasticizers and processing aids.

13. Process for preparing diene elastomer compositions according to any one of claims 5 to 12, characterized in that:
all the necessary constituents, with the exception of the vulcanization agent(s) and, possibly, the vulcanization accelerator(s) and/or the vulcanization activator(s), are introduced into and mixed in a standard internal mixer, in one or two steps, at a temperature ranging from 80° C. to 200° C.;
then the mixture thus obtained is mixed further on an external mixer and the vulcanization agent(s) and, possibly, the vulcanization accelerator(s) and/or the vulcanization activator(s) are then added thereto, at a lower temperature, below 120° C.

14. Elastomer articles, characterized in that they have a body comprising a composition according to any one of claims 5 to 12.

15. Articles according to claim 14, characterized in that they consist of engine mounts, shoe soles, cable-car wheels, seals for domestic electrical appliances and cable jackets.

16. Novel products, which can be used in the formulation of the coupling agents or constituents (i) defined above in any one of claims 1 to 3, characterized in that they consist of linear, cyclic and/or networked siloxane oligomers or mixtures of such oligomers formed from units satisfying the following formulae: (R⁸)₂ZSiO_{1/2}(VI-1), R⁸ZSiO_{2/2} (VI-2) and/or ZSiO_{3/2} (VI-3) in which: the symbols R⁸, which are identical or different, each represent a monovalent radical chosen from the hydroxyl radical and/or the radicals satisfying the definitions of OR¹ and R²; the symbols R¹, R² and Z are as defined above; and the total number of units of formulae (VI-1) to (VI-3), per oligomer molecule, is an integer or fractional number greater than 1.
